(19) United States
(12) Patent Application Publication
(10) Pub. No.: US 2016/0340032 A1
(43) Pub. Date: Nov. 24, 2016

(54) METHOD OF DRIVING AN AIRCRAFT WHEEL IN ROTATION

(71) Applicant: MESSIER-BUGATTI-DOWTY, Velizy Villacoublay (FR)

(72) Inventor: Mathieu DAFFOS, Velizy-Villacoublay (FR)

(73) Assignee: MESSIER-BUGATTI-DOWTY, Velizy Villacoublay (FR)

(21) Appl. No.: 15/096,345

(22) Filed: Apr. 12, 2016

(30) Foreign Application Priority Data
May 22, 2015 (FR) 15 54617

(51) Int. Cl. B64C 25/40; B64C 25/34

(52) U.S. Cl. CPC B64C 25/405; B64C 25/34

(57) ABSTRACT

A method of applying rotary drive by friction to an aircraft wheel that is provided with a drive track and that is mounted to rotate about an axis of rotation (X) on an axle carried by a low portion of aircraft landing gear by means of at least one friction roller (21) driven by a drive actuator (11) and associated with an actuator (23A, 23B, 30) for moving the roller between a disengaged position in which the roller is spaced apart from the drive track of the wheel and an engaged position in which the roller is kept pressed against the drive track. The method includes the step of controlling the force delivered by the actuator while they are holding the roller in the engaged position.

### TECHNOLOGICAL BACKGROUND OF THE INVENTION

Various methods have been proposed for driving a wheel carried by aircraft landing gear. In particular, proposals have been made to drive a wheel by a drive actuator having an outlet gear meshing with a drive gear ring secured to the wheel. In order to allow the wheel to rotate freely, a clutch device is provided between the drive motor and the outlet gear. Nevertheless, the outlet gear remains continuously meshed with the drive gear ring, and that is not favorable from a safety point of view.

Proposals have also been made to use a rotary drive actuator having an outlet shaft carrying a roller that co-operates with a drive track secured to the wheel, enabling torque to be transmitted by friction between the roller and the drive track.

### OBJECT OF THE INVENTION

The invention seeks to provide a method of driving an aircraft wheel in rotation by means of rollers, and enabling the transmission of driving torque to be optimized.

### SUMMARY OF THE INVENTION

To this end, there is provided a method of applying rotary drive by friction to an aircraft wheel that is provided with a drive track and that is mounted to rotate about an axis of rotation on an axle carried by a low portion of aircraft landing gear by means of at least one friction roller driven by a drive actuator and associated with actuator means for moving the roller between a disengaged position in which the roller is spaced apart from the drive track of the wheel and an engaged position in which the roller is kept pressed against the drive track. The method of the invention includes the step of controlling the force delivered by the actuator means while they are holding the roller in the engaged position.

Thus, the radial pressure force of the roller against the drive track exerted by the actuator means can be kept substantially constant by appropriate control, regardless of any deformation of the drive track.

Preferably, the force with which the roller is pressed against the drive track by the actuator means is determined as a function of a torque setpoint for transmitting to the wheel.

Thus, force control makes it possible to generate no more than the radial force that is strictly sufficient for transmitting the necessary torque, thereby avoiding any pointless overloading or fatigue of the roller and of the drive track. In particular, there is no need to transmit a maximum torque continuously. The maximum torque may be developed when starting the aircraft, and the torque may then be reduced for the purpose of sustaining the movement of the aircraft. According to the invention, the force with which the roller is pressed against the drive track of the wheel can thus be modulated in corresponding manner.

In a particular implementation, the pressure force generated by the actuator means is modulated in order to take account of slip between the roller and the drive track of the wheel. Thus, in the event of detecting slip that reduces the amount of torque that can be transmitted, the pressure force is adjusted so as to continue to ensure that the required drive torque is transmitted, e.g. by a transient increase in the pressure force.

### BRIEF DESCRIPTION OF THE FIGURES

The invention can be better understood in the light of the following description of a particular embodiment of the invention given with reference to the figures of the accompanying drawings, in which:

FIG. 1 is a perspective view of the bottom portion of aircraft landing gear (one of the wheels has been omitted for greater clarity), which landing gear is fitted with a drive device of the invention having two drive units;

FIG. 2 is a side view of the FIG. 1 landing gear showing the radial arrangement of the two drive units;

FIG. 3 is a section view of one of the drive units in a plane containing the sliding axis of the slide;

FIG. 4 is a section view of one of the drive units on a plane containing the axes of rotation of the rollers; and

FIGS. 5a and 5b are diagrams showing the disengaged and engaged positions of the rollers on the drive track of the wheel.

### DETAILED DESCRIPTION OF IMPLEMENTATIONS OF THE INVENTION

In order to situate the context of the invention, a device for driving an aircraft wheel by using friction rollers is described in detail. The method of the invention applies to this type of device, and more generally to other types of roller drive devices.

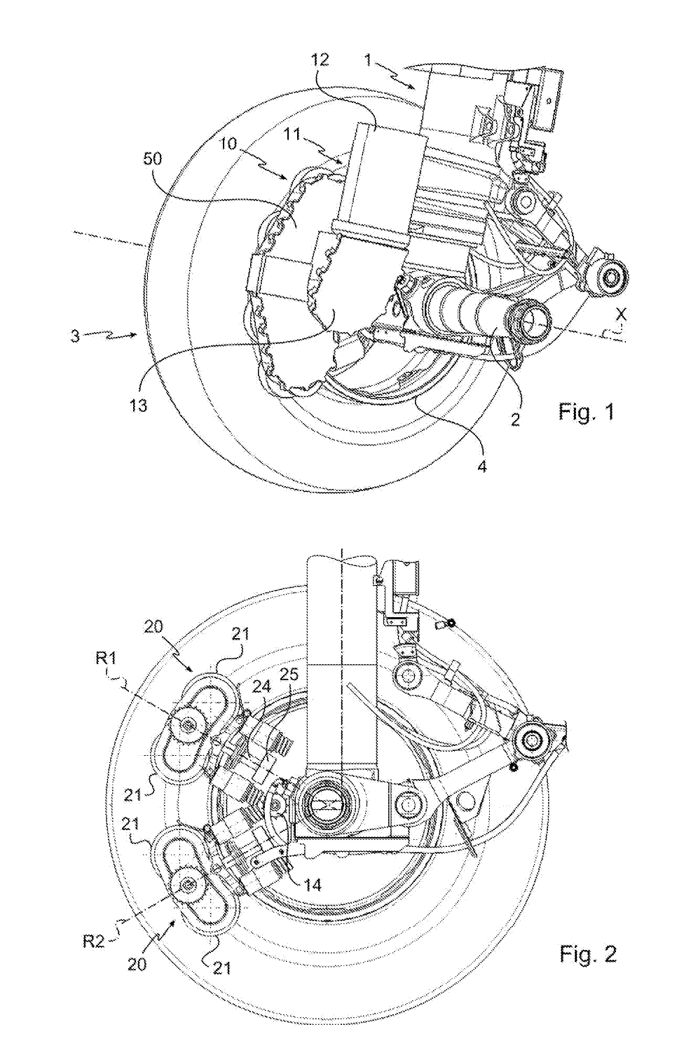

As shown in FIGS. 1 and 2, the invention is applicable to aircraft landing gear 1 having a bottom portion carrying an axle 2 for receiving wheels 3 (only one is shown) and for enabling the wheels to rotate about an axis of rotation X. In this example, each wheel is provided with a drive track 4 that is fitted to the rim of the wheel. The landing gear 1 is provided with a drive device 10 of the invention comprising a drive actuator 11 of which there can be seen an electric motor 12 associated with reduction gearing 13 for driving an outlet shaft (not visible in FIG. 1, but having an outlet sprocket wheel 14 that can be seen in FIG. 2 and in FIG. 6). The actuator 11 is associated with two drive units 20, each having two rollers 21. FIG. 2 shows the general arrangement of the two drive units 20 on two radial directions R1 and R2 that thus extend perpendicularly to the axis X and intersect it.

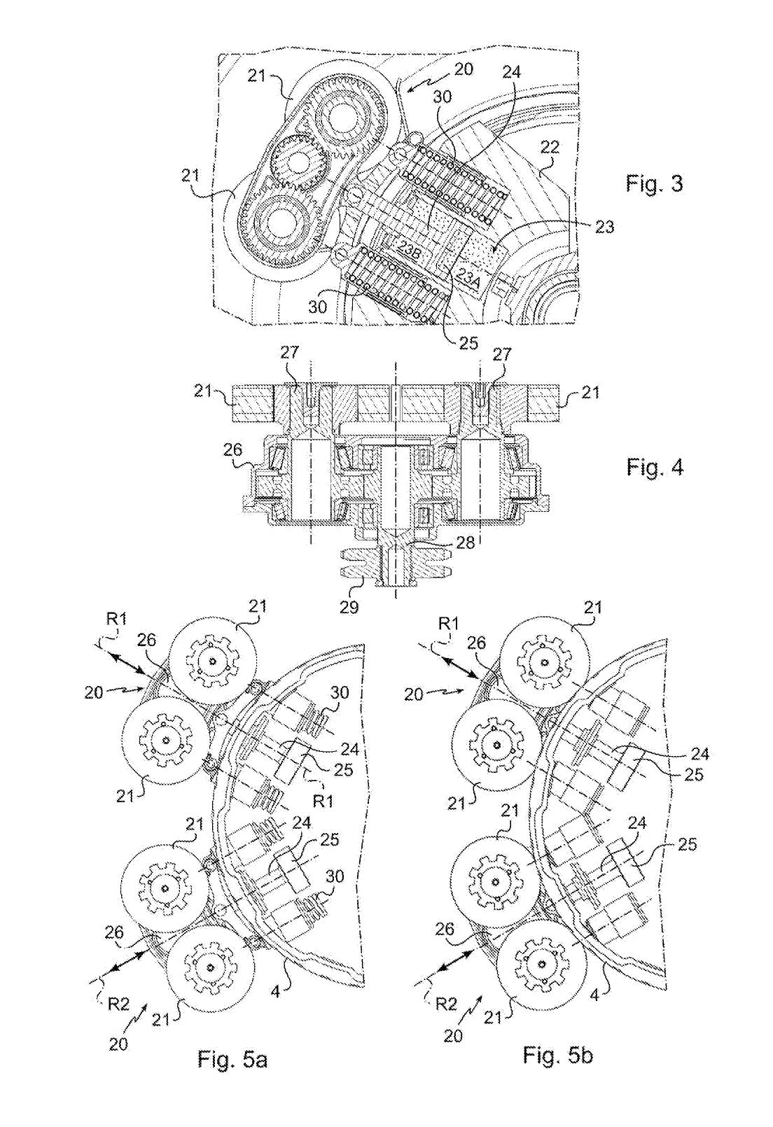

One of the drive units is shown in detail in FIGS. 3 and 4. Each drive unit comprises a base 22 secured to the bottom portion of the landing gear 1. The base 22 defines a cylindrical cavity 23 of central axis that coincides with the radial direction (R1 or R2). A slide 24 is secured to a piston 25 that is mounted to slide in leaktight manner in the cavity 23 so as to define two hydraulic chambers 23A and 23B on either side of the piston 25, which chambers are fed via respective hydraulic ports (not shown). The slide 24 has one end forming an eyelet with a support 26 mounted thereon to pivot about an axis parallel to the axis X. The support 26 receives two shafts 27 supporting the rollers 21 that are mounted to rotate about axes that are parallel to the axis X. The support also receives a central shaft 28 that is mounted to rotate about an axis parallel to the axis X, that meshes with the shafts 27, and that is provided with a driving sprocket wheel 29. The slide 24 co-operates with the cavity 23 to form a hydraulic actuator enabling the support 26 to be moved under control between a disengaged position shown in FIG. 5a, in which the rollers 21 are spaced apart from the drive track 4, and an engaged position shown in FIG. 5b, in which the rollers 21 are in contact with the drive track 4. Springs 30 are arranged on the drive unit 20 in order to exert a force on the support 26 urging the slide 24 and the support 26 towards the disengaged position.

These springs 30 make it possible to use single-acting actuation for the support. Specifically, it suffices to connect both of the hydraulic chambers 23A, 23B to the hydraulic return in order to cause the slide 24 and the support 26 to move towards the disengaged position, which is a stable position. In order to bring the rollers 21 into the engaged position, it suffices to connect the outer hydraulic chamber 23B to the pressure source of the aircraft and thus maintain it under pressure, so as to provide a constant thrust force urging the rollers 21 against the drive track 4, which force is determined by the pressure of the hydraulic circuit.

The fact that the support 26 is free to pivot makes it possible, while the aircraft is taxiing, to guarantee that both rollers come into contact with the drive track with a pressure force that is substantially constant, and regardless of the deformation of the drive track.

Preferably, the ports feeding the outer hydraulic chambers 23B of the two drive units are interconnected, and in the same manner the ports feeding the inner hydraulic chambers 23A are also interconnected. Thus, only two hydraulic lines need to go down along the hydraulic, one being a pressurized fluid feed line and the other being a return line. This provides hydraulic actuator means enabling the rollers to be moved between the disengaged position and the engaged position.

One or more chains (not shown) enable the sprocket wheels 29, and thus the rollers, to be driven in rotation by the drive actuator 11.

According to the invention, the force actuator means are operated while the rollers are held in contact with the drive track in order to impart a determined pressure force of the rollers against the drive track.

In practice, the fluid feed pressure supplied to the chambers 23B is controlled using a pressure servo-valve that is interposed between the aircraft pressure source and the drive units. The force with which the rollers are pressed against the track is proportional to the feed pressure, ignoring friction.

Preferably, the pressure force that is imparted is modulated as a function of the torque that is to be transmitted to the wheel. Specifically, maximum torque is useful only while starting, when the aircraft is stationary. Once the aircraft is moving, it suffices merely to sustain its movement, and it is possible to make do with less torque. Thus, according to the invention, the pressure force of the rollers against the drive track is adjusted to the force that is strictly necessary for ensuring that the desired torque can be transmitted, thereby avoiding any pointless overloading and fatigue.

In a preferred implementation of the method of the invention, a map is used that associates the torque to be transmitted with the hydraulic fluid pressure to be fed to the actuator means. The pressure to be developed in the feed line is thus determined directly as a function of a torque setpoint, which may itself be calculated or which may be the result of a pilot action on the controls.

In a particular aspect of the invention, the pressure force generated by the actuator means is modulated in order to take account of slip between the rollers and the drive track of the wheel.

Specifically, if the slip between the rollers and the drive track is too great, then the transmission of torque is less effective and the rollers become worn prematurely. It is therefore advantageous to keep slip at a value that enables torque to be transmitted optimally. To do this, a slip ratio is calculated on the basis of a measurement of the speed of rotation of the wheel and a measurement of the speed of rotation of the rollers in contact with the drive track. A mean speed of rotation of the rollers can be deduced from the speed of rotation of the outlet shaft of the drive actuator 11. A tangential speed Vt1 for the wheel where it contacts the rollers can be deduced therefrom, as can a tangential speed Vt2 of the rollers where they contact the drive track. The slip ratio SR is estimated as follows:

SR=(Vt2−Vt1)/Vt1

It is known that the coefficient of friction between the rollers and the drive track varies with the slip ratio SR so as to present a curve having a maximum at a given value of the slip ratio (in general very close to the value 10%, referred to as the optimum slip ratio). In a preferred implementation of the invention, the pressure force is modulated in order to ensure that the required drive torque is transmitted. In particular, the pressure force is determined as a function of a drive torque setpoint for transmitting to the wheel.

In a preferred implementation, when slip occurs, as can be detected by real time tracking of the slip ratio, the pressure of the feed fluid is increased transiently in response to detecting slip, until the slip ratio returns substantially to the value of the optimum slip ratio. By way of example, it can be considered that the rollers have started slipping if the slip ratio is greater than a given threshold, e.g. 0.3. Thereafter, once the slip ratio has been returned to a value close to the optimum slip ratio, the pressure is reduced progressively until slip is detected once again, and so on.

The rate at which pressure is reduced should be adjusted to taxiing conditions. Specifically, a large rate of reduction leads to frequent pressure readjustment, thereby pointlessly fatiguing the device, whereas a rate of reduction that is too small runs the risk of keeping the device under high pressure for a length of time that is pointless.

In particular, under wet or rainy taxiing conditions, it is probable that the rollers will be more likely to slip on the drive track of the wheel, thereby requiring a greater pressure to be exerted in order to transmit a given driving torque. The rate at which pressure is reduced should then be smaller in order to avoid too may occasions on which the rollers begin to slip.

In a variant of the invention, on detecting that taxiing is taking place under rainy or wet conditions, a second map is used, referred to as a “wet” map (as contrasted with the usual map, referred to as the “dry” map), which second map, for a given torque that is to be transmitted, gives a pressure that is greater, thereby having the consequence of ensuring that the requested torque is transmitted and reducing the risk of the rollers starting to slip.

The invention is not limited to the above description, but covers any variant coming within the ambit defined by the claims.

In particular, in this example, the method applies to controlling hydraulic actuator means, but it is equally possible to apply it to other types of actuator means, such as electromechanical actuator means. Thus, the above-mentioned maps should be adapted to associate the torque that is to be transmitted with an operating parameter of the actuator means (feed fluid pressure, power supply current, . . . ) that is representative of the pressure force that is to be applied to the rollers.

1.-7. (canceled)

8. A method of applying rotary drive by friction to an aircraft wheel that is provided with a drive track and that is mounted to rotate about an axis of rotation (X) on an axle carried by a low portion of aircraft landing gear by means of at least one friction roller (21) driven by a drive actuator (11) and associated with actuator means (23A, 23B, 30) for moving the roller between a disengaged position in which the roller is spaced apart from the drive track of the wheel and an engaged position in which the roller is kept pressed against the drive track, the method of the invention including the step of controlling the force delivered by the actuator means while they are holding the roller in the engaged position, the pressure force with which the roller is pressed against the drive track by the actuator means being determined as a function of a driving torque setpoint for transmitting to the wheel, and the method being characterized in that a (dry) first map is used that associates the torque that is to be transmitted with an operating parameter of the actuator means (feed fluid pressure, power supply current, . . . ) representative of the pressure force to be applied to the rollers, and a (wet) second map is used in response to detecting taxiing under rainy or wet conditions, which map, for a given torque that is to be transmitted, gives a pressure force that is greater than that given by the first map.

9. The method according to claim 8, wherein the pressure force generated by the actuator means is modulated in order to take account of slip between the roller and the drive track of the wheel.

10. The method according to claim 9, wherein the pressure force is increased in response to detecting that slip is starting, until a slip ratio between the roller and the drive track is returned to an optimum value corresponding to a maximum coefficient of friction.

11. The method according to claim 9, wherein the pressure force is reduced progressively until it is detected that slip is starting.
